(19) United States
(12) Patent Application Publication
(10) Pub. No.: US 2023/0256418 A1
(43) Pub. Date: Aug. 17, 2023

(54) THREE-WAY CATALYST HAVING LOW NH3 FORMATION AND PREPARATION METHOD THEREFOR

(71) Applicant: SINOCAT ENVIRONMENTAL TECHNOLOGY CO., LTD., Chengdu (CN)

(72) Inventors: Yun WANG, Chengdu (CN); Yongxiang CHEN, Chengdu (CN); Hongyi DU, Chengdu (CN); Qin WANG, Chengdu (CN); Haidi XU, Chengdu (CN); Hai LONG, Chengdu (CN); Dengbing XIAN, Chengdu (CN); Renliang HUANG, Chengdu (CN); Tiantian LUO, CHENGDU (CN); Meixia LIU, Chengdu (CN); Cuirong CHEN, Chengdu (CN); Dequan CHEN, Chengdu (CN)

(21) Appl. No.: 18/307,141

(22) Filed: Apr. 26, 2023

Related U.S. Application Data
(63) Continuation of application No. PCT/CN2021/078494, filed on Mar. 1, 2021.

(30) Foreign Application Priority Data
Feb. 6, 2021 (CN) 202110173740.5

(51) Int. Cl. B01J 23/46; F01N 3/10; B01J 6/00; B01J 37/00; B01J 23/44; B01J 23/42; B01J 21/04; B01D 53/94

(52) U.S. Cl. CPC B01J 23/462; B01D 53/945; B01J 6/001; B01J 21/04; B01J 23/42; B01J 23/44; B01J 23/464; B01J 37/0045; F01N 3/101

(57) ABSTRACT

A three-way catalyst having low NH₃ formation is disclosed. The catalyst includes a carrier and a coating material. The coating material includes a precious metal active component and a catalytic material. The precious metal active component includes a first precious metal active component and a second precious metal active component. The first precious metal active component is a composition containing Ru. The second precious metal active component is a composition containing Pt, Pd and Rh. Alternatively, the second precious metal active component is a composition containing Pd and Rh.

### REFERENCE TO RELATED APPLICATIONS

This application is a national phase application of International Application No. PCT/CN2021/078494, filed Mar. 1, 2021, pending, which claims the benefit of Chinese Pat. Appl. No. CN202110173740.5, filed Feb. 6, 2021, both of which are incorporated herein by reference in their entireties.

### TECHNICAL FIELD

The present invention relates to the application of catalysis technology and the environmental protection field related to air pollution control, particularly to a three-way catalyst having low NH₃ formation and preparation method therefor.

### BACKGROUND ART

For vehicles with equivalence ratio combustion, three-way catalyst (TWC) is usually installed on the exhaust pipe to purify Hydrocarbon (HC), nitrogen oxides (NOₓ) and carbon monoxide (CO) in the exhaust gas. The purpose of installing vehicles exhaust purification catalyst is to convert three main pollutants, such as CO, HC and NOₓ, into harmless substances such as CO₂, N₂ and H₂O, while avoiding the generation of new harmful substances. When the vehicle is running under different working conditions, the concentration, flow rate, temperature and air-fuel ratio of pollutants in the exhaust gas fluctuate greatly, and TWC usually has multiple main reactions and side reactions. Part of the main reaction and side reaction (main reaction: CO+H₂O→CO₂+H₂, HC+H₂O → CO₂+H₂; Side reaction: NO+H₂→NH₃+H₂O, CO+NO+H₂→NH₃+H₂O) will lead to the formation of new pollutant NH₃ on TWC. NH₃ is a colorless, irritating and foul-smelling gas, which is harmful to human skin, eyes and respiratory organs. GB17691-2018 “Emission Limits and Measurement Methods of Pollutants from Heavy Diesel Vehicles (China’s Sixth Stage)” stipulates that NH₃ emitted from vehicles exhaust should not exceed 10 ppm.

The literature (Applied Thermal Engineering 130 (2018) 1363-1372) reported the NH₃ emission of a heavy-duty natural gas engine (equivalence ratio combustion) equipped with TWC. In WHTC (World Harmonized Transient Cycle) test, the NH₃ emission exceeded 100 ppm, with the highest exceeding 450 ppm; under more than 80% of the working conditions. The steady state 13 operating point test shows that in 11 of the 13 operating point conditions, the NH₃emissionexceeds 100 ppm, with the highest exceeding 300 ppm. The literature (Atmospheric Environment 97 (2014) 43-53) compares and verifies seven light gasoline vehicles equipped with TWC (equivalence ratio combustion). The test results of NEDC (New European Driving Cycle, New European Cycle Test) show that the highest NH₃ emission is 108 ppm, and the lowest NH₃ emission is 6 ppm. The NH₃ emission of different vehicles is quite different, which is mainly related to vehicle emission control system and after-treatment catalyst. Literature (Science of the Total Environment 616-617 (2018) 774-784) compares the NH₃ emissions of diesel vehicles with DOC+DPF (lean combustion) and natural gas vehicles with TWC (equivalence ratio combustion) in different test cycles. The results show that the NH₃ emissions of diesel vehicles are all lower than 10 mg/km, but the NH₃ emissions of natural gas vehicles are 13-24 mg/km. The above literature shows that it is a common phenomenon that the equivalent combustion car with TWC has higher NH₃ emission. It is necessary to solve the problem that the equivalent combustion car with TWC has higher NH₃ emission than that with TWC by installing other catalysts to purify NH₃ or by reducing the amount of TWC NH₃generated (improving the selectivity of TWC N₂). Chinese patent (CN109225316 A) introduces a kind of TWC+AOC (ammonia oxidation catalyst, AOC for short), which can purify the byproduct NH₃ generated by TWC through AOC. TWC+AOC can effectively purify CO, HC and NOₓ, and at the same time reduce NH₃ emission to below 10 ppm. This technical route is widely used in the national six heavy-duty natural gas vehicles in China. Through AOC, the problem of NH₃ emission exceeding the standard of equivalent combustion vehicle with TWC can be solved. However, after adding AOC, the calibration difficulty of engine after-treatment system increases, the volume of exhaust purification catalytic converter increases and the cost increases to a certain extent.

### SUMMARY OF THE INVENTION

The purpose of the present invention is to provide a three-way catalyst with low NH₃ formation, aiming at the problems in the prior art that the excess NH₃ emission of equivalent combustion vehicles equipped with TWC can be solved by AOC, but after the AOC is added, the calibration difficulty of the engine after-treatment system increases, the volume of the exhaust purification catalytic converter increases and the cost increases to a certain extent. In this catalyst, by adding ruthenium metal or ruthenium oxide into TWC, the N₂ selectivity of TWC is improved, and the NH₃formation is reduced. This scheme is a new and more effective technical scheme to solve the problem of NH₃ emission exceeding the standard.

In order to achieve the above object, the technical scheme adopted by the present invention is:

A three-way catalyst having low NH₃ formation, which consists of a carrier and a coating material;
the coating material consists of a precious metal active component and a catalytic material;
the precious metal active component includes a first precious metal active component and a second precious metal active component;
the first precious metal active component is a composition containing Ru;
the second precious metal active component is a composition containing Pt, Pd and Rh; Or the second precious metal active component is a composition containing Pd and Rh.

The three-way catalyst having low NH₃ formation of the present invention improves the N₂ selectivity of TWC by adding metallic ruthenium (Ru) and/or ruthenium oxide into the coating material, and inhibits the NH₃formation of TWC byproduct. The NH₃formation is reduced from the source, and part of the generated NH₃ is decomposed into N₂ and H₂ on Ru catalyst, which greatly reduces the NH₃ formation, reduces the volume and cost of catalytic converter, and more effectively solves the problem of NH₃ emission exceeding the standard. Among them, platinum, palladium and rhodium are commonly used precious metals of three-way catalysts.

As a preferred scheme of the present invention, the content of Ru is 1 ~ 100 g/ft³ in terms of simple substance.

When the content of ruthenium is in the range of 1 ~ 100 g/ft³, the NH₃formation is all lower than 10 ppm, and the NH₃formation is very low, showing high N₂ selectivity.

As a preferred scheme of the present invention, the content of Ru is 5 ~ 40 g/ft³ in terms of simple substance.

As the content of ruthenium increases, the NH₃formation gradually decreases. When the content of ruthenium is too high, the production cost increases. In the above range, it shows high N₂ selectivity and reduces the cost.

When the content of ruthenium is not 0, it can all play a role in reducing the NH₃ formation. With the increase of ruthenium content, the NH₃formation decreases. The ruthenium content is 0.05, 0.1, 0.2, 0.3, 0.5, 0.8, 1, 2, 2.5, 3, 5, 10, 20, 25, 30, 40, 50, etc., and the unit is g/ft³.

As a preferred scheme of the present invention, the Ru composition contains metallic ruthenium and/or ruthenium oxide.

The content and proportion of the second precious metal active component, the coating loading amount, etc., are the conventional dosage of commercial TWC.

As a preferred scheme of the present invention, the catalytic material comprises an oxygen storage material and an alumina material.

As a preferred scheme of the present invention, the oxygen storage material comprises CeO₂, CeO₂—ZrO₂, CeO₂—ZrO₂—Y₂O₃, CeO₂—ZrO₂—La₂O₃—Y₂O₃, CeO₂—ZrO₂—La₂O₃—Pr₂O₃, CeO₂—ZrO₂—La₂O₃—La₂O₃.

As a preferred scheme of the present invention, the alumina material comprises pure alumina; At least one of modified alumina such as La and Ce.

As a preferred scheme of the present invention, the carrier is a ceramic carrier or a metal carrier. The ceramic carrier is a cordierite ceramic carrier.

The present invention also provides a preparation method of the three-way catalyst having low NH₃ formation as described above, comprising the following steps,

S1, preparation of coating material;

loading the salt solution of the first precious metal active component and the salt solution of the second precious metal active component onto a catalytic material; Drying and calcining to obtain a coating material;

S2, preparation of coating material slurry;

mixing the coating material, water, and binder, and ball milling slurry is obtained to obtain coating material slurry;

S3, prepares three-way catalyst;

Coating the coating material slurry on the carrier, and drying and calcining to obtain the three-way catalyst.

The preparation method of the invention is that Ru and other precious metal active components are loaded on oxygen storage materials and alumina together, then dried, calcined and solidified, and finally slurry is coated on cordierite ceramic carriers or metal carriers.

To sum up, due to the adoption of the above-mentioned technical scheme, the beneficial effects of the present invention are:

1. The three-way catalyst having low NH₃ formation of the present invention by adding metallic ruthenium, in which the content of Ru is 1-100 g/ft³, more preferably 5-40 g/ft³improves the N₂ selectivity of TWC. Compared with the existing three-way catalyst, it can achieve a high-efficiency purification equivalence ratio of CO/HC/NOₓ in the combustion of vehicles exhaust, and at the same time, the amount of NH₃ generated is also greatly reduced, avoiding the use of AOC and other methods to remove the NH₃formation, reducing the volume of the catalytic converter.

2. The preparation method of the three-way catalyst adopted by the invention avoids the mixed preparation of multiple catalysts, and the process is simpler. This preparation method is the traditional preparation process of vehicles exhaust purification catalyst, which greatly reduces the production cost and is easier to scale up and industrialize.

### BRIEF DESCRIPTION OF THE DRAWINGS

FIG. 1 is CO conversion efficiency curve of the catalysts prepared in the comparative example and embodiment of the present invention prepares to. In FIG. 1, C1-1 and C2-1 are the catalysts of Comparative Example 1 and Comparative Example 2, and C3-1, C4-1 and C5-1 are the catalysts of embodiment 1, embodiment 2 and embodiment 3.

FIG. 2 is the HC (CH₄) conversion efficiency curve of the catalysts prepared in the comparative example and the embodiment of the present invention. In FIG. 2, C1-1 and C2-1 are the catalysts of comparative Example 1 and embodiment 2, and C3-1, C4-1 and C5-1 are the catalysts of embodiment 1, embodiment 2 and embodiment 3.

FIG. 3 is the NOₓ (NO) conversion efficiency curve of the catalysts prepared in the comparative example and the embodiment of the present invention. In FIG. 3, C1-1 and C2-1 are the catalysts of Comparative Example 1 and embodiment 2, and C3-1, C4-1 and C5-1 are the catalysts of embodiment 1, embodiment 2 and embodiment 3.

FIG. 4 shows the different LambdaNH₃formation of the catalysts prepared by the comparative examples and embodiments of the present invention. In FIG. 4, C1-1 and C2-1 are catalysts of comparative example 1 and embodiment 2, and C3-1, C4-1 and C5-1 are catalysts of embodiment 1, embodiment 2 and embodiment 3.

### DETAILED DESCRIPTION OF THE INVENTION

The following describes the present invention in detail with reference to the drawings.

In order to make the purpose, technical scheme and advantages of the present invention clearer, the present invention will be further explained in detail below with reference to the drawings and examples. It should be understood that the specific embodiments described herein are only used to explain the present invention, but not for limiting the present invention.

### Comparative Example 1

S1, preparation of coating material;

The Pd(NO₃)₂ and Rh(NO₃)₂ solutions were loaded on Al₂O₃ and CeO₂—ZrO₂ materials by dipping method, dried at 80° C. for 6 h, and calcined at 500° C. for 2 h to obtain a coating material, denoted as M1.

S2, preparation of coating material slurry;

Mix M1 with water and a binder to obtain a coating material slurry, denoted as N1.

S3, prepares three-way catalyst;

The N1 is coated on the cordierite ceramic carrier, and the carrier size is Φ25.4*101.6/400 cpsi. After drying at 80° C. for 6 h and calcining at 500° C. for 2 h, the coating amount is 200 g/L, the total content of Pd and Rh is 35 g/ft³, and the ratio of Pd and Rh is 9:1. The prepared catalyst is denoted as C1-1.

The N1 is coated on the cordierite ceramic carrier, and the carrier size is Φ304.8*152.4/400 cpsi. After drying at 80° C. for 6 h and calcining at 500° C. for 2 h, the coating amount is 200 g/L, the total content of Pd and Rh is 35 g/ft³, and the ratio of Pd and Rh is 9:1. The prepared catalyst is denoted as C1-2.

### Comparative Example 2

S1, preparation of coating material;

The Pt(NO₃)₂, Pd(NO₃)₂ and Rh(NO₃)₂ solutions were loaded onto the La—Al₂O₃ and CeO₂—ZrO₂ materials by dipping, dried at 80° C. for 6 h, and calcined at 500° C. for 2 h to obtain a coating. Layer material, denoted as M2.

S2, preparation of coating material slurry;

The M2 is mixed with water and a binder to obtain a coating material slurry, which is denoted as N2.

S3, prepares three-way catalyst;

The N2 is coated on the cordierite ceramic carrier, and the carrier size is 25.4+101.6/400 cpsi. After drying at 80° C. for 6 h and calcining at 500° C. for 2 h, the coating amount is 200 g/L, the total content of Pt, Pd and Rh is 35 g/ft³, and the ratio of Pt, Pd and Rh is 3:6:1. The prepared catalyst was denoted as C2-1.

N2 is applied to the cordierite ceramic carrier, the carrier size is Φ304.8*152.4/400 cpsi. After drying at 80° C. for 6 h and calcining at 500° C. for 2 h, the coating amount is 200 g/L, the total content of Pt, Pd and Rh is 35 g/ft³, and the ratio of Pt, Pd and Rh is 3:6:1. The prepared catalyst is denoted as C2-2.

### Embodiment 1

S1, preparation of coating material;

The Pd(NO₃)₂, Rh(NO₃)₂ and Ru(NO₃)₂ solutions were loaded onto Al₂O₃ and CeO₂—ZrO₂ materials by impregnation method, dried at 80° C. for 6 h, and calcined at 500° C. for 2 h to obtain a coating material, denoted as M3.

S2, preparation of coating material slurry;

The M3 is mixed with water and a binder to obtain a coating material slurry, which is denoted as N3.

S3, prepares three-way catalyst;

The N3 is coated on the cordierite ceramic carrier, the carrier size is Φ25.4*101.6/400 cpsi. After drying at 80° C. for 6 h and calcining at 500° C. for 2 h, the coating amount is 200 g/L, the total content of Pd and Rh is 35 g/ft³, the ratio of Pd and Rh is 9:1, and the content of Ru is 5 g/ft³. The prepared catalyst was denoted as C3-1.

The N3 is coated on the cordierite ceramic carrier, and the carrier size is Φ304.8*152.4/400 cpsi. After drying at 80° C. for 6 h and calcining at 500° C. for 2 h, the coating amount is 200 g/L, the total content of Pd and Rh is 35 g/ft³, the ratio of Pd and Rh is 9:1, and the content of Ru is 5 g/ft³. The prepared catalyst is denoted as C3-2.

### Embodiment 2

S1, the preparation of coating material;

Pt(NO₃)₂, Pd(NO₃)₂, Rh(NO₃)2 and Ru(NO₃)₂ solutions were loaded onto La—Al₂O₃ and CeO₂—ZrO₂ materials by impregnation method, dried at 80° C. for 6 h, 500° C. calcined for 2 h to obtain a coating material, denoted as M4.

S2, preparation of coating material slurry;

The M4 is mixed with water and a binder to obtain a coating material slurry, which is denoted as N4.

S3, prepares three-way catalyst;

The N4 is coated on a cordierite ceramic carrier with a carrier size of 25.4*101.6/400 cpsi. After drying at 80° C. for 6 h and calcining at 500° C. for 2 h, the coating amount is 200 g/L, the total content of Pt, Pd and Rh is 35 g/ft³, the ratio of Pt, Pd and Rh is 3:6:1, and the Ru content is 20 g/ft³. The prepared catalyst is denoted as C4-1.

The N4 is coated on the cordierite ceramic carrier, the carrier size is Φ304.8*152.4/400 cpsi. After drying at 80° C. for 6 h and calcining at 500° C. for 2 h, the coating amount is 200 g/L, the total content of Pt, Pd and Rh is 35 g/ft³, the ratio of Pt, Pd and Rh is 3:6:1, and the Ru content is 20 g/ft³. The prepared catalyst is denoted as C4-2.

### Embodiment 3

S1, the preparation of coating material;

Pt(NO₃)2, Pd(NO₃)2, Rh(NO₃)2 and Ru(NO₃)₂ solutions were loaded onto La—Al₂O₃ and CeO₂—ZrO₂ materials by impregnation method, dried at 80° C. for 6 h, and calcined at 500° C. for 2 h to obtain a coating material, which is denoted as M5.

S2, preparation of coating material slurry;

The M5 is mixed with water and a binding agent to obtain a coating material slurry, denoted as N5.

S3, prepares three-way catalyst;

The N5 is coated on a cordierite ceramic carrier with a carrier size of Φ25.4*101.6/400 cpsi. After drying at 80° C. for 6h and calcining at 500° C. for 2h, the coating amount is 200 g/L, the total content of Pt, Pd and Rh is 35 g/ft³, the ratio of Pt, Pd and Rh is 3:6:1, and the Ru content is 40 g/ft³. The prepared catalyst was denoted as C5-1.

The N5 is coated on the cordierite ceramic carrier, the carrier size is Φ304.8*152.4/400 cpsi. After drying at 80° C. for 6h and calcining at 500° C. for 2 h, the coating amount is 200 g/L, the total content of Pt, Pd and Rh is 35 g/ft³, the ratio of Pt, Pd and Rh is 3:6:1, and the Ru content is 40 g/ft³. The prepared catalyst is denoted as C5-2. Test example 1

Catalyst C1-1, C2-1, C3-1, C4-1 and C5-1 obtained in above-mentioned comparative example and embodiment are carried out activity evaluation test on vehicles exhaust sample simulation device, test condition is as follows:

Simulated atmosphere: HC (CH₄): 1000 ppm; CO: 4000 ppm; NO: 1000 ppm; O₂: 3500 ppm; H₂O: 10%; CO₂: 10%; N₂ is the balance gas, and the airspeed is 40,000 h-1 (the airspeed calculated according to the volume of TWC). The patent of the present invention adopts CH₄ with the most stable structure to represent HC in vehicles exhaust gas; NOₓ is adopted to represent NOₓ (including NOₓ such as NO and NO₂) in vehicles exhaust gas. The catalysts were tested for the conversion efficiency of CO, CH₄ and NO at 300-600° C. (the main temperature range of vehicles exhaust) under the simulated atmosphere.

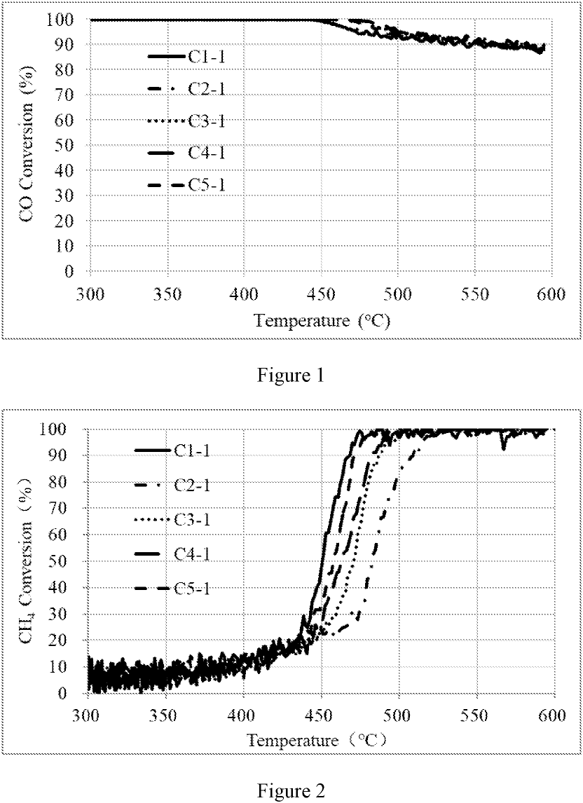

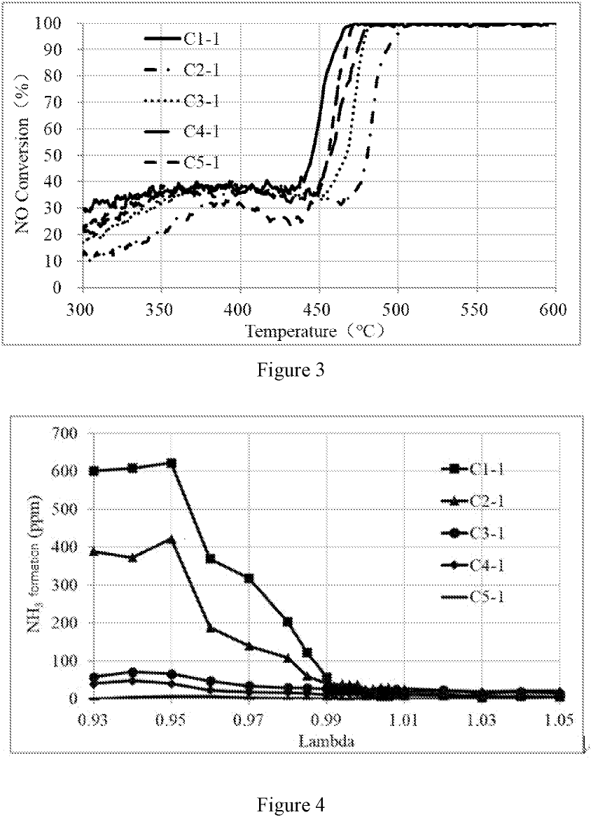

FIG. 1, FIG. 2 and FIG. 3 are the corresponding catalysts C1-1, C2-1, C3-1, C4-1 of comparative example 1, comparative example 2, embodiment 1, embodiment 2 and embodiment 3 respectively and the conversion efficiency curves of C5-1 to three pollutants of CO, CH₄ and NO.

FIG. 1 result shows, comparative example and embodiment all have very high conversion efficiency to CO, and performance difference is little.

The results of FIG. 2 show that, for the light-off temperature performance of CH₄, the activity of embodiment 1 is slightly lower than that of comparative example 1; the activities of embodiment 2 and comparative example 2 are basically equivalent; the above results show that the TWC prepared according to the patented preparation process and catalytic material of the present invention, the addition of metal Ru has inconsistent effects on the activity of PtPdRh and PdRh type, the activity of PdRh type TWC is slightly inhibited, and the activity of PtPdRh type TWC has almost no effect, even with the increase of Ru addition, the activity of PtPdRh-type TWC was slightly improved.

The results of FIG. 3 show that the influence characteristics of each embodiment and the comparative example on the light-off temperature performance of NO are consistent with the law of CH₄.

### Test Example 2

The catalysts C1-1, C2-1, C3-1, C4-1 and C5-1 obtained in the comparative examples and embodiments are verified different lambda NH₃ on the vehicles exhaust sample simulation device (N₂ Selectivity), The test conditions are as follows:

Simulated atmosphere: HC (CH₄): 1000 ppm; CO: 4000 ppm; NO: 1000 ppm; H₂O: 10%; CO₂: 10%; N₂ is the balance gas, and the airspeed is 40,000 h-1 (the airspeed calculated according to the volume of TWC). O₂ content is determined according to the Lambda value. The patent of the present invention adopts CH₄ with the most stable structure to represent HC in vehicles exhaust gas; NOₓ is adopted to represent NOₓ (including NOₓ such as NO and NO₂) in vehicles exhaust gas. The catalyst was tested at 500° C. in a simulated atmosphere (this temperature is the temperature at which the TWC NH₃formation is relatively high, and the average exhaust temperature of the vehicles exhaust is also near this, so it is more representative to choose this temperature test),The NH₃formation of each comparative example and embodiment at different Lambdas. Lambda is the equivalent air-fuel ratio.

FIG. 4 is the NH₃ formation of corresponding catalyst C1-1, C2-1, C3-1, C4-1 and C5-1 of comparative example 1, comparative example 2, embodiment 1, embodiment 2 and embodiment 3 at lambda value when 0.93-1.05. The five curves in FIG. 4 correspond to C1-1, C2-1, C3-1, C4-1 and C5-1 in order from top to bottom.

The results of FIG. 4 show that the NH₃formation of the embodiment is greatly reduced compared with the comparative example, indicating that the addition of metal Ru has a significant effect on the reduction of the catalyst NH₃formation. Compared with embodiment 1 and embodiment 2, when lambda is less than 1, the formation ofNH₃ in embodiment 3, decreases to a certain extent, which shows that the addition amount of Ru also affects the formation of NH₃. With the increase of the addition amount, the formation of NH₃ will decrease slightly.

### Test Example 3

The catalyzer C1-2, C2-2, C3-2, C4-2 and C5-2 that above-mentioned comparative example and embodiment are obtained are in the gas engine bench of heavy-duty equivalence ratio combustion, according to the test method specified inGB17691-2016″Diesel Vehicle Pollutant Emission Limits and Measurement Methods (China Phase VI)″ validates the WHTC test cycle conditions, comparative examples and implementation of CO, HC (CH₄), NOₓ and NH₃ emission values.

Table 1 shows results of the corresponding catalysts C1-2, C2-2, C3-2, C4-2 and C5-2 of comparative example 1, comparative example 2, embodiment 1, embodiment 2 and embodiment 3 according to WHTC cycle and the CO, HC(CH₄), NOₓ and NH₃ emission values of the operating conditions test.

TABLE 1

The emission values of pollutants in engine bench WHTC test of comparative example and embodiments.

| [symbol] | CO | HC (CH₄) | NOₓ | NH₃ |
|---|---|---|---|---|
| | mg/kWh | mg/kWh | mg/kWh | ppm |
| [symbol] | 4000 | 500 | 460 | 10 |
| C1-2 | 199 | 19 | 192 | 36.4 |
| C2-2 | 259 | 25 | 208 | 32.7 |
| C3-2 | 200 | 51 | 224 | 2.48 |
| C4-2 | 341 | 40 | 202 | 1.71 |
| C5-2 | 342 | 36 | 209 | 0.36 |

### Pollutants

### National VI Limit

The results in Table 1 show that the three pollutants of embodiment and Comparative Example, CO, HC(CH₄) and NOₓ, are all purified to within 50% of the national six limit, showing very high pollutant purification efficiency. The NH₃formation of comparative example 1 and comparative example 2 is more than three times of the national six limit, and the emission exceeds the standard; the NH₃formationof embodiment 1, embodiment 2 and embodiment 3 are all lower than 10 ppm, the NH₃formationis very low, showing high N₂ selectivity. The above results show that, while embodiment 1, embodiment 2 and embodiment 3 efficiently purify CO, CH₄ and NOₓ, NH₃ emission is greatly reduced and N₂ selectivity is greatly improved.

The above discusses preferred embodiments of the present invention, and is not intended to limit the present invention. Any modification, equivalent substitution, improvement, etc. made within the spirit and principle of the present invention should be included in the scope of protection of the present invention.

1. A three-way catalyst, comprising a carrier and a coating material, the coating material comprising a precious metal active component and a catalytic material, wherein:
the precious metal active component includes a first precious metal active component and a second precious metal active component;
the first precious metal active component comprises Ru; and
the second precious metal active component comprises Pd and Rh, and optionally, Pt.

2. The three-way catalyst according to claim 1, wherein the Ru is present in the first precious metal active component in an amount of 1 ~ 100 g/ft³.

3. The three-way catalyst according to claim 2, wherein the Ru is present in the first precious metal active component in an amount of 5 ~ 40 g/ft³.

4. The three-way catalyst according to claim 1, wherein the Ru in the first precious metal active component contains metallic ruthenium and/or ruthenium oxide.

5. The three-way catalyst according to claim 1, wherein the catalytic material comprises an oxygen storage material and an alumina material.

6. The three-way catalyst according to claim 5, wherein the oxygen storage material comprises CeO₂, CeO₂—ZrO₂, CeO₂—ZrO₂—Y₂O₃, CeO₂—ZrO₂—La₂O₃—Y₂O₃, CeO₂—ZrO₂—La₂O₃—Pr₂O₃, or CeO₂—ZrO₂—La₂O₃—La₂O₃.

7. The three-way catalyst according to claim 5, wherein the alumina material comprises pure alumina or a modified alumina containing La and/or Ce.

8. The three-way catalyst according to claim 1, wherein the carrier comprises a ceramic carrier or a metal carrier.

9. A method for preparing the three-way catalyst according to claim 1, comprising:
loading a first salt solution of the first precious metal active component and a second salt solution of the second precious metal active component onto a catalytic material;
drying and calcining the catalytic material with the first and second salt solutions loaded thereon to obtain a coating material;
mixing the coating material, water, and a binder to obtain a coating material slurry;
coating the coating material slurry on the carrier; and
drying and calcining the carrier with the coating material slurry thereon to obtain the three-way catalyst.
